(19) United States
(12) Patent Application Publication
(10) Pub. No.: US 2026/0239465 A1
(43) Pub. Date: Aug. 13, 2026

(54) METHODS, ARCHITECTURES, APPARATUSES AND SYSTEMS FOR INACTIVE STATE MOBILITY FOR MULTIPATH SIDELINK RELAYING AND PATH SELECTION IN RELEASE

(71) Applicant: InterDigital Patent Holdings, Inc., Wilmington, DE (US)

(72) Inventors: Martino FREDA, Laval (CA); Oumer TEYEB, Montreal (CA); Tuong HOANG, Montreal (CA); Ananth KINI, Conshohocken, PA (US)

(21) Appl. No.: 19/153,086

(22) PCT Filed: Feb. 1, 2024
(86) PCT No.: PCT/US2024/014055

§ 371 Date: Aug. 1, 2025

Related U.S. Application Data
(60) Provisional application No. 63/443,198, filed on Feb. 3, 2023.

(51) Int. Cl. H04W 76/15; H04W 76/30

(52) U.S. Cl. CPC H04W 76/15; H04W 76/30

(57) ABSTRACT

Among the procedures, methods, architectures, apparatuses, systems, devices, and computer program products disclosed herein for multipath relaying isa wireless transmit/receive unit (WTRU) configured to: receive, from a network node, configuration information for configuring, by the WTRU, a multipath connection, the multipath connection comprising a direct path via a first link with the network node and an indirect path via a second link, the second link being a sidelink associated with a sidelink relay WTRU; receive, from the network node, first system information on a first serving cell, the first serving cell being associated with the direct path; receive, from the network node, a message to release the direct path; perform a serving cell change from the first serving cell to a second serving cell, the second serving cell being associated with the indirect path; and receive, from the sidelink relay WTRU, second system information of the second serving cell.

### CROSS-REFERENCE TO RELATED APPLICATIONS

This application claims the benefit of U.S. Provisional Patent Application No. 63/443,198 filed Feb. 3, 2023, which is incorporated herein by reference in its entirety.

### FIELD

The present disclosure is generally directed to the fields of communications, software and encoding, including, for example, to methods, architectures, apparatuses, systems directed to perform multipath sidelink relaying and path selection in release.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a user plane protocol stack for L2 U2N relay;

FIG. 3 is a control plane protocol stack for L2 U2N relay;

FIG. 4 is a flowchart illustrating a representative method implemented by a remote WTRU configured for multipath connection on a direct path via a Uu link to a network node and an indirect path to the network node via a sidelink (SL) associated with a sidelink relay wireless transmit receive unit (WTRU);

FIG. 5 is a flowchart illustrating a further representative method implemented by a remote WTRU configured for multipath connection on a direct path via a Uu link to a network node and an indirect path to the network node via a SL associated with a sidelink relay WTRU; and

FIG. 6 is a flowchart illustrating a representative method for performing a serving cell change implemented by a WTRU.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

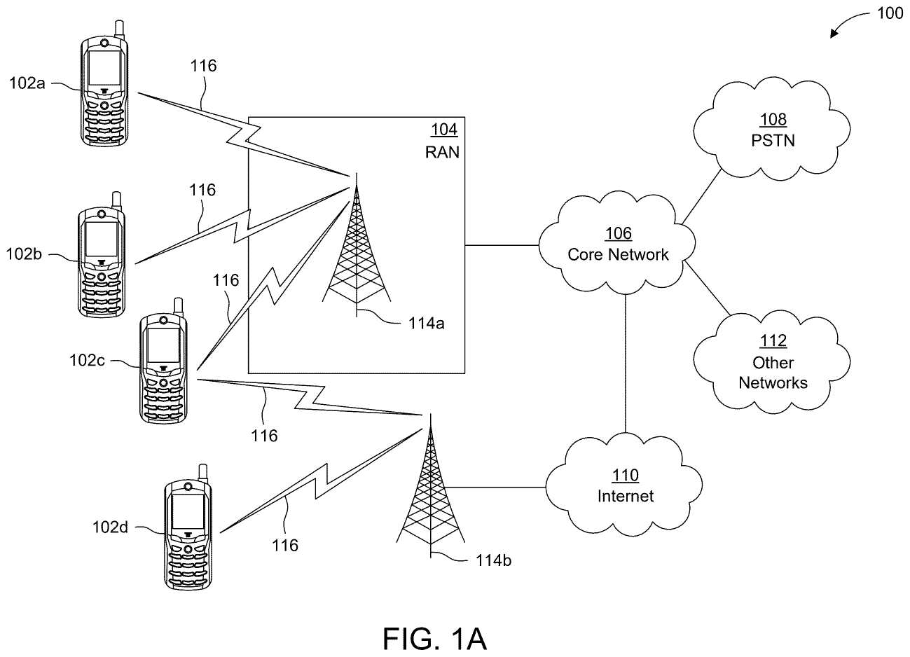

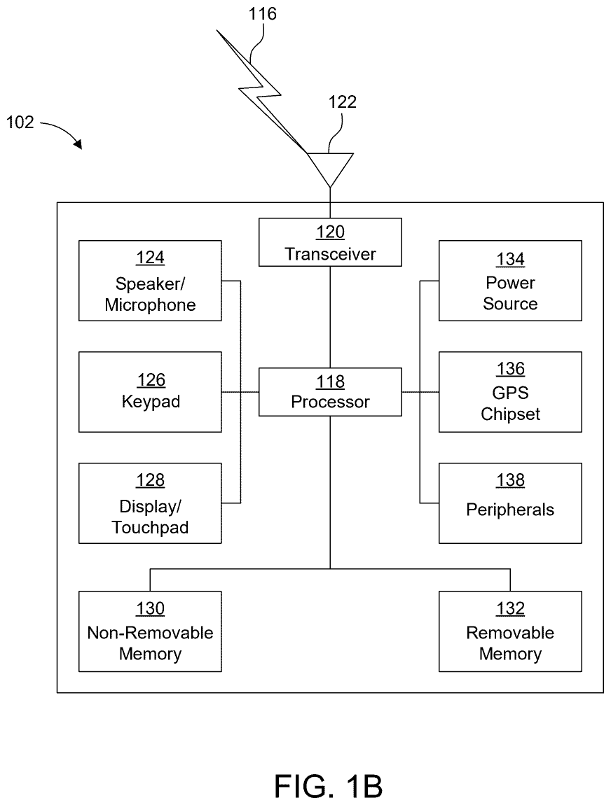

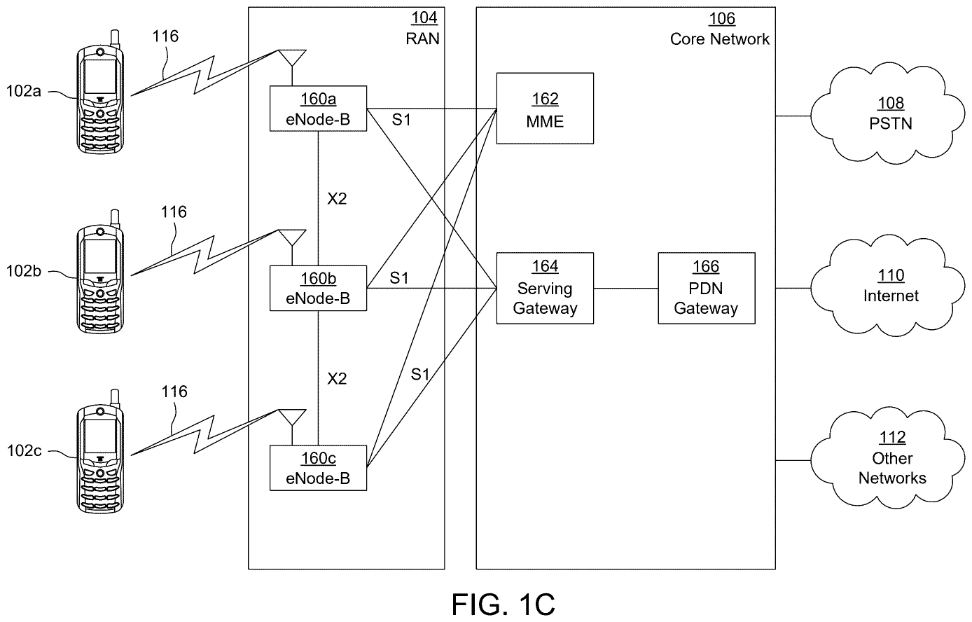

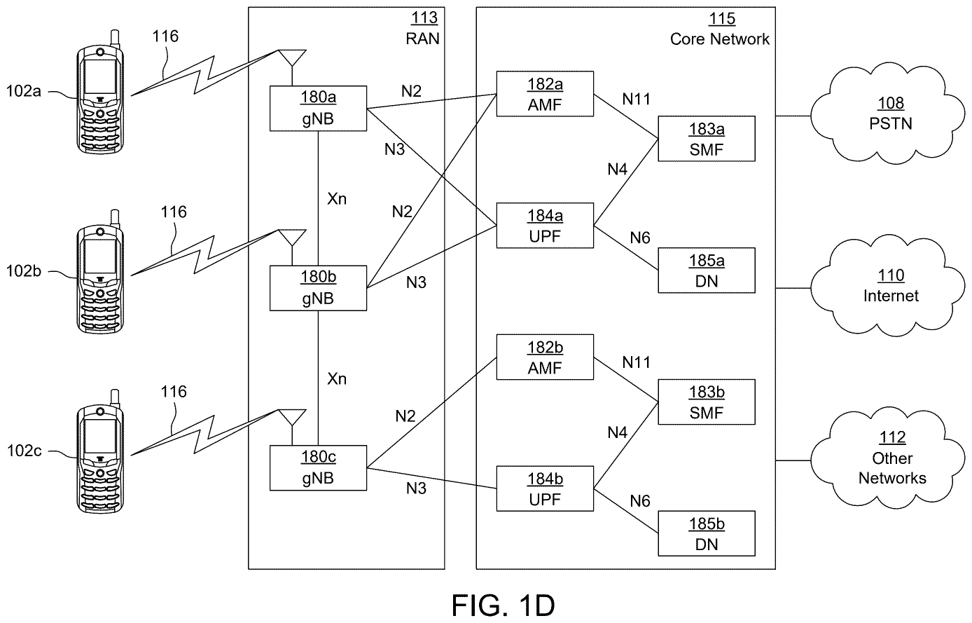

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA 2000 EV-DO, Interim Standard 2000(IS-2000 ), Interim Standard 95(IS-95 ), Interim Standard 856(IS-856 ), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU (e.g., UE) to network (NW) relay architecture is described hereafter.

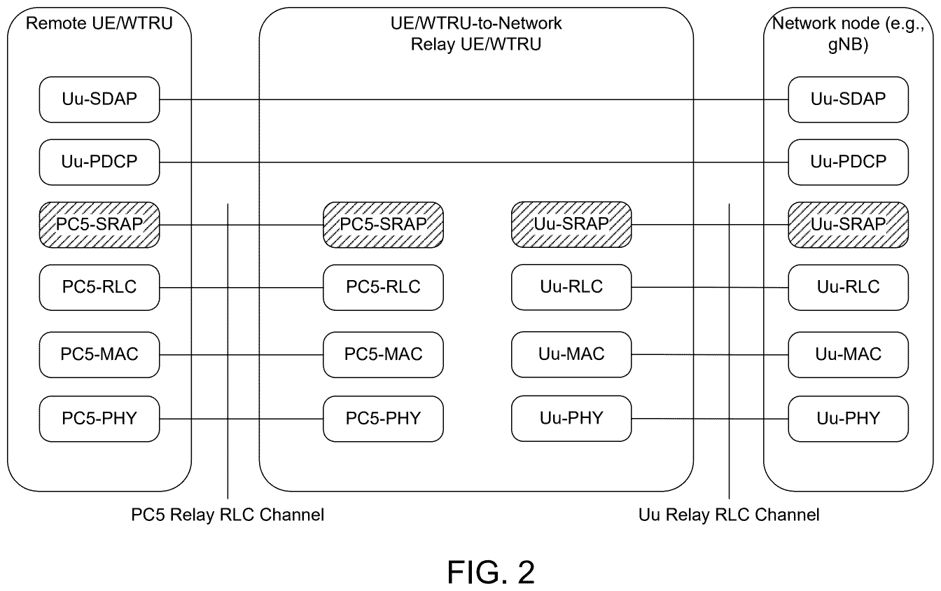

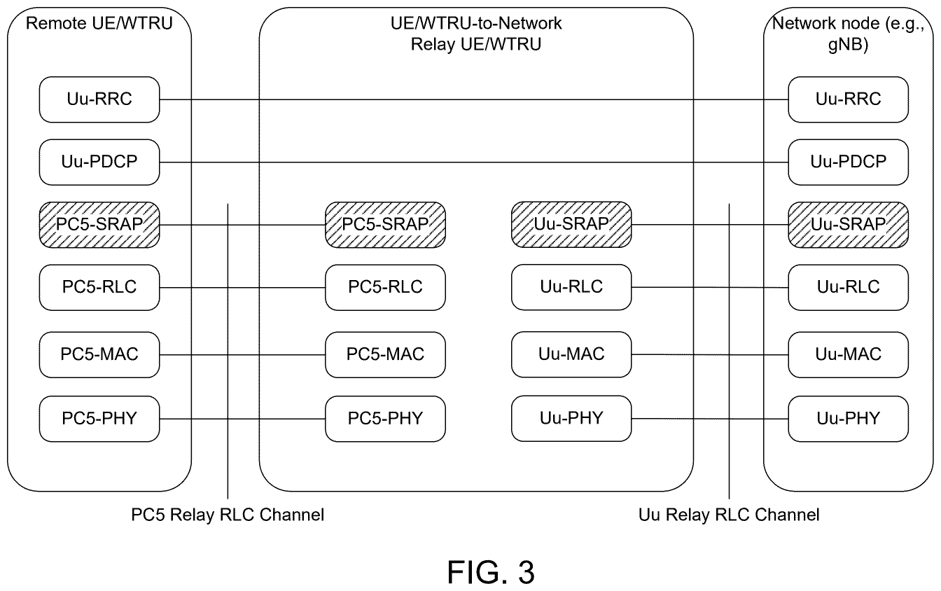

The protocol stacks for the user plane and control plane of L2 UE/WTRU-to-network (U2N) relay architecture are illustrated in FIGS. 2 and 3. The sidelink relay adaptation protocol (SRAP) sublayer may be placed above the radio link control (RLC) sublayer for both control plane (CP) and user plane (UP) at both PC5 interface and Uu interface. The Uu service data adaptation protocol (SDAP), packet data convergence protocol (PDCP) and radio resource control (RRC) may be terminated between a L2 U2N remote WTRU (e.g., UE) and a network node (e.g., gNB), while SRAP, RLC, MAC and physical layer (PHY) may be terminated in each hop (i.e., the link between L2 U2N remote WTRU (e.g., UE) and the L2 U2N relay WTRU (e.g., UE) and the link between L2 U2N relay WTRU (e.g., UE) and the network node (e.g., gNB)).

For L2 U2N relay, the SRAP sublayer over PC5 hop may be (e.g., only) for the purpose of bearer mapping. The SRAP sublayer may not be present over PC5 hop for relaying the L2 U2N remote WTRU's (e.g., UE's) message on broadcast control channel (BCCH) and paging control channel (PCCH). For L2 U2N remote WTRU's (e.g., UE's) message on signaling radio bearer type 0 (SRB0), the SRAP header may not be present over PC 5 hop, but the SRAP header may be present over Uu hop for both DL and UL.

An inactive state for legacy WTRUs (e.g., UEs) and remote WTRUs (e.g., UEs) with WTRU (e.g., UE) to NW Relays is described hereafter.

A legacy NR WTRU (e.g., UE) can move to an inactive (e.g., RRC_INACTIVE) state, for example, following reception of a release message. While in inactive state (e.g., RRC_INACTIVE), the WTRU (e.g., UE) may maintain its RRC context (e.g., bearer configuration, security context), but the WTRU may release the RRC connection. The WTRU (e.g., UE) may perform an idle mode mobility, with the difference that it may perform RAN area updates, for example, in the case where (e.g., when) it (re)selects a cell which may be outside the configured RAN area.

A remote WTRU (e.g., UE) may move to inactive state (e.g., RRC_INACTIVE) state while PC5-RRC connected to the relay WTRU (e.g., UE) (for example in release 8). Because the remote WTRU (e.g., UE) may be assumed to be in out of coverage (OOC), the inactive state (e.g., RRC_INACTIVE) may be assumed to be via the relay WTRU (e.g., UE) (i.e., with an active PC5-RRC connection). The remote WTRU (e.g., UE) may perform cell/relay reselection while in inactive state (e.g., RRC_INACTIVE) and/or may perform RAN area update, for example, in the case where (e.g., when) it selects a cell (or a relay that may be connected to a cell) which may be outside the configured RAN area.

In single path relaying, a relay WTRU (e.g., UE) may be used to extend coverage. A WTRU (e.g., UE) in inactive state (e.g., RRC_INACTIVE) can perform cell or relay (re)selection to (e.g., always) maintain connectivity to the network. The WTRU (e.g., UE) can generally move between different relays due to mobility.

Multipath relaying may be used for different purposes/use cases. It may be used for XR use cases, for example, where the link between the relay and the remote WTRU (e.g., UE) may be static, and where the reliability of the link can be low (e.g., in the case it uses Bluetooth, Wi-Fi, etc.) or high (e.g., in the case of a wired connection). It may be used for increased reliability using sidelink relays deployed densely in an area. Depending on the use case, the WTRU (e.g., UE) may have different inactive state (e.g., RRC_INACTIVE) behavior with respect to:
How the WTRU (e.g., UE) may receive paging, system information (SI) while in inactive state (e.g., RRC_INACTIVE): for example, reception of paging via the indirect link may not be preferrable for a Bluetooth/Wi-Fi connection; and for example, reception of paging via the relay may be preferred to avoid having the network broadcast the paging message.
How the WTRU (e.g., UE) may perform inactive state (e.g., RRC_INACTIVE) mobility: for example, whether the remote WTRU (e.g., UE) should favor reselection from relay/cell to cell/relay or not; and
Whether there may be a need to maintain the multipath configuration.
Etc.

Applying dual connectivity (DC) procedures in the case where (e.g., when) the WTRU (e.g., UE) may be connected in multipath may not provide the flexibility to address the specific case. In DC, the WTRU (e.g., UE) may (e.g., always) have an identified master cell group (MCG), comprising a primary cell (PCell), which may be used for the inactive state (e.g., RRC_INACTIVE) anchor.

In an embodiment to be described hereinbelow, a method for a network (NW) controlled path selection in release is proposed.

In an embodiment to be described hereinbelow, a method, by a remote WTRU (e.g., UE) connected in multipath, is proposed to determine its inactive state (e.g., RRC_INACTIVE) behavior (paging/SI monitoring, PC5-RRC connection, etc. ,) based on a path indication (direct and/or indirect) in the release message and to indicate any changes in the potential multipath status/ configuration and behavior while in multipath (e.g., whether the WTRU can resume in either path, which path may be considered primary, etc.).

In an embodiment, a remote WTRU (e.g., UE), in a connected state (e.g., RRC_INACTIVE) to the network with a multipath configuration, may be configured for:
Receiving, from the network, a release message including a release to indirect indication.
Upon reception of such indication, the remote WTRU (e.g., UE) may perform any of the following actions:
   maintains the inactive state (e.g., RRC_INACTIVE) (e.g., performs WTRU (e.g., UE) based mobility, performs resume upon data reception, etc.) via the indirect path (i.e., via the relay);
   maintains the PC5-RRC connection;
   monitors for paging and SI via sidelink (SL) (e.g., only); and
   if the remote WTRU (e.g., UE) moves out of coverage of the network or releases the PC5-RRC connection:
      triggers a resume procedure and indicates that the resume may be as a result of moving out of coverage, in the resume cause.

In an embodiment to be described hereinbelow, a method for a NW signaled path change is proposed.

In an embodiment to be described hereinbelow, a method, for a remote WTRU (e.g., UE), is proposed to change from one inactive state (e.g., RRC_INACTIVE) behavior (e.g., path used for paging/SI monitoring) to another by reception of an indication from the network (e.g., paging message).

In an embodiment, a remote UE, may be configured to perform any of the following actions:
receiving, from the network, a release message indicating to maintain the multipath configuration, and indicating the path over which to monitor paging/SI;
performing paging/SI monitoring via the path indicated by the release message;
changing the current path for paging/SI monitoring following reception of a message from the network (e.g., paging message) indicating a current path change; and
in the case where (e.g., when) data arrives at the WTRU (e.g., UE): initiating a resume procedure via the indicated current path.

In this disclosure, the term “anchor path” for the inactive state (e.g., RRC_INACTIVE) may refer to the path of the multipath (e. g .., either direct via Uu, or indirect via WTRU (e.g., UE) to NW relay) which may be assumed as the path to the network by the remote WTRU (e.g., UE) in the case where (e.g., when) in inactive state (e.g., RRC_INACTIVE). The anchor path for the inactive state (e.g., RRC_INACTIVE) may dictate any of the following WTRU (e.g., UE) behavior while in inactive state (e.g., RRC_INACTIVE):

Paging reception: For example, if the anchor path is direct, the remote WTRU (e.g., UE) may monitor its paging occasions on Uu. If the anchor path is indirect, the remote WTRU (e.g., UE) may not monitor its paging occasions on Uu, and may determine (e.g., assume) it receives paging via a SL RRC message. For example, if the anchor path is direct, the remote WTRU (e.g., UE) may monitor all of its paging occasions on Uu. If the anchor path is indirect, the remote WTRU (e.g., UE) may monitor only a subset of its paging occasions on Uu.

System Information request/reception: For example, if the anchor path is direct, the remote WTRU (e.g., UE) may request/receive SI via the Uu interface. If the anchor path is indirect, the remote WTRU (e.g., UE) may request/receive SI from the relay WTRU (e.g., UE). For example, if the anchor path is direct, the remote WTRU (e.g., UE) may request/receive SI via the Uu interface. If the anchor path is indirect, the remote WTRU (e.g., UE) may request SI from the relay WTRU (e.g., UE) but receive SI via the direct path.

PC5-RRC connection: For example, if the anchor path is direct, the remote WTRU (e.g., UE) may release the PC5-RRC connection with the relay. If the anchor path is indirect, the remote WTRU (e.g., UE) may keep the PC5-RRC connection.

Resume for data arrival: For example, if the anchor path is direct, the remote WTRU (e.g., UE) may initiate a resume procedure via a direct path upon data arrival. If the anchor path is indirect, the remote WTRU (e.g., UE) may initiate a resume procedure via the indirect path upon data arrival.

The following section describes an embodiment of a method for NW/UE controlled path selection in release. In an embodiment, a remote released can be released with/without multipath knowledge in the release message.

In an embodiment, a remote WTRU (e.g., UE) with a multipath configuration in inactive state/mode (e.g., RRC_INACTIVE) may receive a release to an inactive state/mode that indicates whether a remote WTRU (e.g., UE) should maintain or release the multipath configuration, which may comprise (e.g., consist of) the split bearer configuration or any context related to the multipath configuration. A remote WTRU (e.g., UE) may further trigger resume procedure, for example, based on the triggers described herein in the case where the remote WTRU (e.g., UE) may be indicated to maintain the multipath configuration.

A remote WTRU (e.g., UE) may be released without multipath configuration and indicated to operate on Uu. The remote WTRU (e.g., UE) may perform any of the following actions:
release the PC5-RRC connection, and the SL configuration associated with the relay;
release any relaying bearers (bearers which may be configured to use the relaying path only);
release the relayed leg of any split bearers;
change the primary path of any split bearers from the relayed path to the Uu path, if any of the bearers are configured with the relayed path as the primary path;
release the configuration of some bearers and maintain the configuration of others: for example, a bearer configured via the Uu link may be maintained and suspended, while a bearer configured via the relay link may be released. For example, a split bearer may be released if its primary path is via the relay, but it may be maintained if its primary path is via the Uu (and the remote WTRU (e.g., UE) may only release the relay leg of the split bearer);
consider the serving cell to be the cell associated with the Uu path;
initiate paging monitoring and SI monitoring via the Uu path following the release; and
release any configuration associated to multipath.

Following the release in such case, the remote WTRU (e.g., UE) may operate as a legacy WTRU (e.g., UE) in inactive state (e.g., RRC_INACTIVE) without any relay.

A remote WTRU (e.g., UE) may be released without multipath configuration and indicated to operate via the SL relay to which it may be PC5-RRC connected. The remote WTRU (e.g., UE) may perform any of the following actions:
maintain the PC5-RRC connection, and the SL configuration associated with the relay;
release any direct Uu bearers (bearers which may be configured to use the Uu path only);
release the non-relayed leg of any split bearers;
change the primary path of any split bearers from the direct Uu path to the relayed path, if any of the bearers are configured with the direct path as the Uu path;
release the configuration of some bearers and maintain the configuration of others: for example, a bearer configured via the relay link may be maintained and suspended, while a bearer configured via the Uu link may be released. For example, a split bearer may be released if its primary path is via the Uu, but it may be maintained if its primary path is via the relay (and the remote WTRU (e.g., UE) may (e.g., only) release the Uu leg of the split bearer);
consider the serving cell to be the cell associated with the relayed path;
determine/assume paging and SI monitoring to be received via the relayed path following the release, and not monitor the Uu link; and
release any configuration associated with multipath.

Following the release, the remote WTRU (e.g., UE) may operate as a legacy remote WTRU (e.g., UE) in inactive state (e.g., RRC_INACTIVE) connected via a SL relay (i.e., as though it may be OOC).

The remote WTRU (e.g., UE) may receive an (e.g., explicit) indication in the release message (e.g., the remote WTRU (e.g., UE) may receive a “path type” IE which may be either direct or indirect). The remote WTRU (e.g., UE) may determine/assume one path (e.g., direct) if an indication is not included in the release message, and may determine/assume another path (e.g., indirect) if an indication is included in the release message.

In an embodiment, a remote WTRU (e.g., UE) may determine the anchor path at release based on (e.g., implicit) signaling and/or measurements occurring while in inactive state (e.g., RRC_INACTIVE). For example, based on any of:
Radio resource management (RRM) measurements: for example, a remote WTRU (e.g., UE) may determine the anchor path at release based on conditions associated with the last successfully reported RRM measurements while in inactive state (e.g., RRC_INACTIVE). For example, if the relay quality is above a threshold and the Uu cell quality is below a threshold in the last reported measurement while in inactive state (e.g., RRC_INACTIVE), the remote WTRU (e.g., UE) may determine/assume the anchor path at release to be the indirect path.
SL measurements: for example, a remote WTRU (e.g., UE) may determine the anchor path at release based on conditions associated with SL measurements, for example, which were reported to the network. For example, if the last reported channel busy ratio (CBR) measurements indicate a CBR which is larger than a configured threshold, the remote WTRU (e.g., UE) may determine/assume the anchor path at release to be the direct path.
RRC signaling path: for example, a remote WTRU (e.g., UE) may determine the anchor path at release to be the primary path of the SRB while in connected state (e.g., RRC_INACTIVE) (i.e., the path where the primary RLC entity may be configured in for the SRB, where SRB could be SRB1 or SRB2, or both-assuming they may be configured in the same way). For example, a remote WTRU (e.g., UE) may determine the anchor path at release to be the path over which the remote WTRU (e.g., UE) (e.g., successfully) sent/received its last RRC message prior to the release. For example, a remote WTRU (e.g., UE) may determine the anchor path at release to be the path over which the remote WTRU (e.g., UE) may receive the release message sending it to inactive state (e.g., RRC_INACTIVE).
Cell relationship: for example, the remote WTRU (e.g., UE) may use a first rule described herein for determining the anchor path in the case where (e.g., when) the cell associated with the direct and indirect paths may be the same (or part of the same configured cell group), and may use a second rule described herein for determining the anchor path in the case where (e.g., when) the cell associated with the direct and indirect paths may be different (or may be part of different configured cell groups).
The path associated with the WTRU's (e.g., UE's) PCell: For example, the remote WTRU (e.g., UE) may determine the anchor path as the path where the cell may be the PCell.
The primary path of one or more split data bearers, or the path of one or more data bearers: for example, the remote WTRU (e.g., UE) may determine the anchor path as the path where the majority of not split bearers may be configured, where the majority of split bearers may have their primary path configured, where the bearer configured with the highest priority may be configured or may have its primary path configured, etc.

In an embodiment, a remote WTRU (e.g., UE) may receive an indication to maintain the multipath configuration or some part of the multipath configuration. A remote WTRU (e.g., UE) may (e.g., further) receive an indication in the release message of the path (direct path or indirect path) to be used as the anchor path for the inactive state (e.g., RRC_INACTIVE) while maintaining the multipath configuration (or portion of the multipath configuration). The remote WTRU (e.g., UE), in the case where (e.g., when) it may move to inactive state (e.g., RRC_INACTIVE), may determine the anchor path (as described herein) based on the indication in the release message, or based on the implicit/WTRU (e.g., UE) based conditions described above. If the remote WTRU (e.g., UE) is moved to inactive state (e.g., RRC_INACTIVE) with anchor on Uu, the remote WTRU (e.g., UE) may camp on the serving cell via Uu. If the remote WTRU (e.g., UE) is moved to inactive state (e.g., RRC_INACTIVE) with anchor via the relay, the remote WTRU (e.g., UE) may camp on the serving cell via the relay.

In an embodiment, a remote WTRU (e.g., UE) may perform any of the following actions: maintain the knowledge of the multipath configuration, and use such knowledge during mobility events in inactive state (e.g., RRC_INACTIVE) (as discussed below);
consider the serving cell to be the cell associated with the anchor path;
bearers may be handled in any of the following ways: the remote WTRU (e.g., UE) may suspend all bearers, including any multipath bearers, or bearers associated with the non-anchor path. In such a case, data arriving at a split bearer may be routed via the anchor path. Data arriving at a split bearer may be routed via any path and the WTRU (e.g., UE) may perform different resume procedure depending on data arrival path. The remote WTRU (e.g., UE) may release all bearers configured on the non-anchor path, as well as the legs of the bearers on the non-anchor path; and
determine/assume paging and SI monitoring to be received via the anchor path.

The following section describes an embodiment wherein a WTRU (e.g., UE) may perform resume/mobility taking knowledge of multipath into account while in inactive state (e.g., RRC_INACTIVE).

In an embodiment, a remote WTRU (e.g., UE) in inactive state (e.g., RRC_INACTIVE) may perform mobility procedures which take the knowledge of multipath into account.

In an embodiment, a remote WTRU (e.g., UE) may perform a resume procedure in the case where (e.g., when) one of the paths fails and/or the remote WTRU (e.g., UE) may be unable to maintain one/both of the paths associated with multipath. The resume procedure by the remote WTRU (e.g., UE) may be performed on the path opposite to the path which exhibited the failure. For example, a remote WTRU (e.g., UE) may perform a resume procedure via the relay path/Uu path if any one of the following actions occur:
The remote WTRU (e.g., UE) moves OOC of Uu: for example, upon such an event, the remote WTRU (e.g., UE) may perform a resume procedure via the relay WTRU (e.g., UE).
The PC5-RRC connection fails, for example, SL radio link failure (RLF) occurs, SL reconfiguration fails, or the remote WTRU (e.g., UE) receives a SL release from the relay WTRU (e.g., UE): for example, upon such an event, the remote WTRU (e.g., UE) may perform a resume procedure via Uu.
The remote WTRU (e.g., UE) performs a cell reselection while camping via Uu: for example, upon a cell reselection on the Uu interface by the WTRU (e.g., UE) with multipath knowledge, the WTRU (e.g., UE) may perform a resume procedure, for example via Uu, for example via SL (for example with the link selected by the remote WTRU (e.g., UE) based on conditions described herein).
The remote WTRU (e.g., UE) performs relay reselection while camping via the relay: for example, upon a relay reselection while the remote WTRU (e.g., UE) may camp via the relay, the WTRU (e.g., UE) may perform a resume procedure, for example via Uu, for example via SL (for example with the link selected by the remote WTRU (e.g., UE) based on conditions described herein). For example, upon relay reselection in which the remote WTRU (e.g., UE) may camp via the relay, and/or under the condition that the relay reselection may result in a change of cell, or change of cell area (e.g., tracking area update(TAU)), the WTRU (e.g., UE) may perform a resume procedure, for example via Uu, for example via SL (for example selected by the remote WTRU (e.g., UE) based on conditions described herein).
The remote WTRU (e.g., UE) performs relay reselection or cell reselection which results in the new serving cell being accessible via (e.g., only) one path: for example, if the remote WTRU (e.g., UE) performs relay reselection and is camped (via the relay) on a cell in which the remote WTRU (e.g., UE) may be OOC with respect to Uu, the remote WTRU (e.g., UE) may perform a resume procedure.
The remote WTRU (e.g., UE) performs relay reselection or cell reselection which results in a different cell or cell group than the cell(s) to which the WTRU (e.g., UE) was attached while in connected state (e.g., RRC_CONNECTED) being the new serving cell: for example, if the remote WTRU (e.g., UE) performs relay reselection or cell reselection and ends up camped on a cell which was not one of the cell(s) to which the remote WTRU (e.g., UE) was connected via either path in Uu or via relay, the remote WTRU (e.g., UE) can initiate a resume procedure.
The remote WTRU (e.g., UE) receives an indication from the relay WTRU (e.g., UE) indicating any of: (1) cell reselection by the relay, for example where the new cell satisfies a condition described herein; (2) handover (HO) by the relay, for example where the target cell satisfies a condition described herein; (3) Uu RLF by the relay; or (4) connection establishment failure: for example, a remote WTRU (e.g., UE) may perform a resume procedure via the relay, and such resume procedure may result in reception by the remote WTRU (e.g., UE) of a failure of the connection. The remote WTRU (e.g., UE) may, as a result, perform resume procedure via Uu, for example including the associated cause value in the resume message, as described herein.

In an embodiment, the WTRU (e.g., UE) may perform a resume procedure following a period of time after the event, where the event may be not resolved within that time. For example, if the WTRU (e.g., UE) moves OOC, the WTRU (e.g., UE) may initiate a timer, and if it does not move back in coverage prior to the expiry of the timer, it may initiate resume.

In an embodiment, a WTRU (e.g., UE) may indicate the mobility event in the resume message.

A remote WTRU (e.g., UE) may indicate the event of the mobility in the resume request message (e.g., by including a cause value in the resume request). Any of the events above may be associated with a cause value. For example, the remote WTRU (e.g., UE) may include a specific cause value in the resume request message (via the relay UE) in the case the remote WTRU (e.g., UE) moves OOC in the case where (e.g., when) camped via Uu. For example, the remote WTRU (e.g., UE) may include a (e.g., specific) cause value in the resume request message (via Uu) in the case the remote WTRU (e.g., UE) may experience SL RLF.

The following section describes an embodiment with a NW signaled path change.

The following section describes an embodiment wherein a WTRU (e.g., UE) may receive a NW triggered message/indication to change the anchor path.

In an embodiment, a remote WTRU (e.g., UE) in inactive state (e.g., RRC_INACTIVE), for example where a portion/knowledge of the multipath configuration may be maintained, may receive a message/indication from the network to change the anchor path.

The remote WTRU (e.g., UE) may receive such indication in any of the following: (1) a paging message; (2) a RRC message, MAC CE, or a data packet received while in inactive state (e.g., RRC_INACTIVE) (e.g., via small DL data transmissions); and (3) an indication in SIB.

Such message may indicate to change the anchor path from the current path to another path. Such message may indicate to change the anchor path to Uu. Such message may indicate to change the anchor path to the relayed path.

Changing the anchor path for mobility may refer to any one of the behaviors discussed on sections above.

The remote UE, upon reception of such message, and in the case the indicated path may be different than the current anchor path, may perform any of the operations associated with changing the anchor path (e.g., assuming the anchor path may be changed to the other path) described herein. Furthermore, the remote WTRU (e.g., UE) may also perform any of the following:
Initiate a resume procedure via the new anchor path indicated in the NW indication: the remote WTRU (e.g., UE) may further provide a cause value specific to this case in the resume request message.
Release the configuration associated with the other path: for example, if the remote WTRU (e.g., UE) receives a paging message moving the anchor path from relayed to Uu, the relay WTRU (e.g., UE) may release the PC5-RRC connection, the SL configuration associated with the relay, etc. For example, the remote WTRU (e.g., UE) may further perform such release procedure if the paging message further indicates such action. For example, the remote WTRU (e.g., UE) may further perform such release procedure.

The following section describes an embodiment wherein a WTRU (e.g., UE) may receive a NW triggered message/indication to release the multipath configuration and associated behavior.

In an embodiment, a similar message (paging, SIB indication, etc.) as a path switched may be used to release the multipath configuration and behavior. Upon reception of such a message, the remote WTRU (e.g., UE) may initiate legacy inactive state (e.g., RRC_INACTIVE) behavior. The remote WTRU (e.g., UE) may (e.g., continue to) perform SIB/paging monitoring over the current anchor path. The WTRU (e.g., UE) may operate based on legacy behavior as a result of the mobility events mentioned herein. Namely:
in the case where (e.g., when) configured with Uu as the anchor path, and in the case where (e.g., when) moving OOC, the remote WTRU (e.g., UE) may trigger initial setup, rather than resume; and
in the case where (e.g., when) configured with SL as the anchor path, and in the case where (e.g., when) triggering SL RLF, the remote WTRU (e.g., UE) may trigger initial setup, rather than resume.

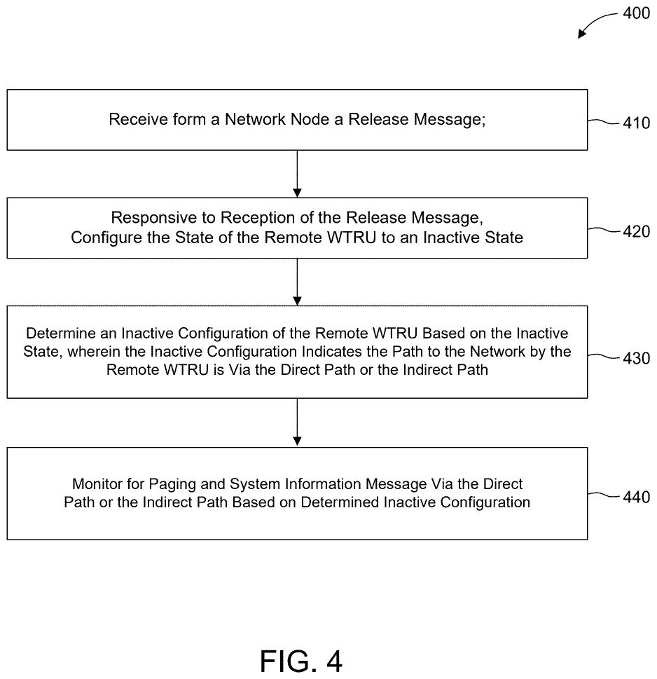

FIG. 4 is a flowchart illustrating a representative method 400 implemented by a remote WTRU configured for multipath connection on a direct path via a Uu link to a network node and an indirect path to the network node via a SL associated with a sidelink relay WTRU.

Referring to FIG. 4, the representative method 400 may include, at block 410, receiving from the network node a release message. At block 420, responsive to the reception of the release message, the representative method 400 may include configuring the state of the remote WTRU to an inactive state. At block 430, the representative method 400 may include determining an inactive configuration of the remote WTRU based on the inactive state, wherein the inactive configuration indicates the path to the network by the remote WTRU may be via the direct path or the indirect path. At block 440, the representative method 400 may include monitoring for paging and system information message via the direct path or the indirect path based on the determined inactive configuration.

In certain representative embodiments, the representative method 400 may further comprise determining the inactive configuration of the remote WTRU based on an indication included in the release message.

In certain representative embodiments, the representative method 400 may further comprise determining the inactive configuration of the remote WTRU based on signaling and/or measurements occurring while in inactive state.

In certain representative embodiments, the representative method 400 may further comprise if the inactive configuration indicates that the path to the network by the remote WTRU is via the direct path, releasing the sidelink.

In certain representative embodiments, the representative method 400 may further comprise if the remote WTRU is out of coverage of the network or releases the sidelink connection, triggering a resume procedure and indicating in a resume cause that the resume may be as a result of moving out of coverage.

In certain representative embodiments, the release message may be an RRC-RELEASE message and/or the sidelink may be a PC5-RRC connection.

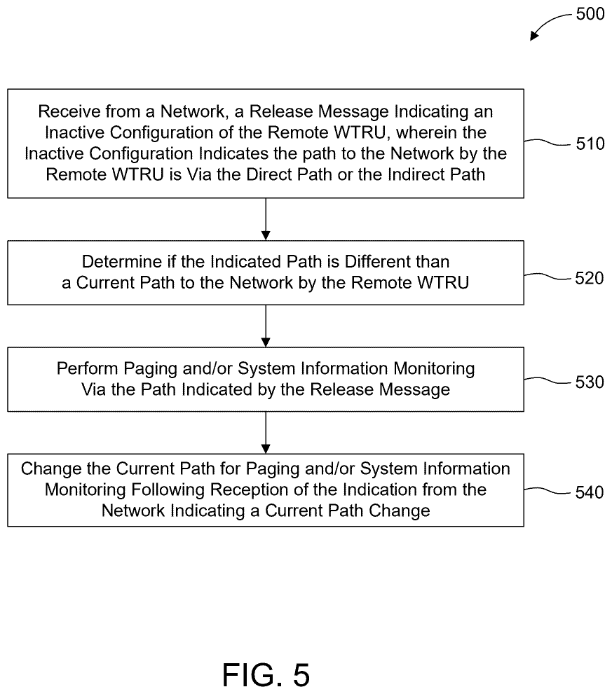

FIG. 5 is a flowchart illustrating a representative method 500 implemented by a remote WTRU configured for multipath connection on a direct path via a Uu link to a network node and an indirect path to the network node via a SL associated with a sidelink relay WTRU.

Referring to FIG. 5, the representative method 500 may include, at block 510, receiving, from the network, a release message indicating an inactive configuration of the remote WTRU, wherein the inactive configuration indicates the path to the network by the remote WTRU may be via the direct path or the indirect path. At block 520, the representative method 500 may include, determining if the indicated path is different than a current path to the network by the remote WTRU, at block 530, performing paging and/or system information monitoring via the path indicated by the release message, and at block 540 changing the current path for paging and/or system information monitoring following reception of the indication from the network indicating a current path change.

In certain representative embodiments, the indication from the network indicating a current path change may be any of: (1) a paging message, (2) a RRC message, MAC CE, or a data packet received while in inactive state, and (3) an indication in a system information block.

In certain representative embodiments, the representative method 500 may further comprise, responsive to the reception of data, initiating a resume procedure via the indicated path.

In certain representative embodiments, the representative method 500 may further comprise, sending information in a resume request message to the network node indicating a cause associated to a resume request associated to the resume procedure.

In certain representative embodiments, the representative method 500 may further comprise, releasing the configuration associated with the direct path if the indicated path is the indirect path or releasing the configuration associated with the indirect path if the indicated path is the direct path.

In certain representative embodiments, the release message may be an RRC-RELEASE message and/or the sidelink may be a PC5-RRC connection.

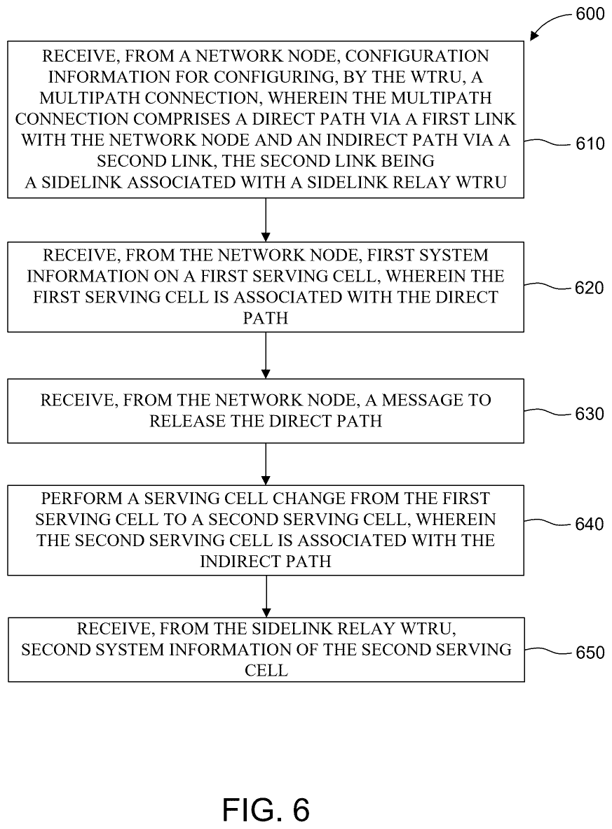

FIG. 6 is a flowchart illustrating a representative method 600 implemented by a WTRU.

Referring to FIG. 6, the representative method 600 may include, at block 610, receiving, from a network node, configuration information for configuring, by the WTRU, a multipath connection, wherein the multipath connection may comprise a direct path via a first link with the network node and an indirect path via a second link, the second link being a sidelink associated with a sidelink relay WTRU. At block 620, the representative method 600 may include, receiving, from the network node, first system information on a first serving cell, wherein the first serving cell may be associated with the direct path. At block 630, the representative method 600 may include, receiving, from the network node, a message to release the direct path. At block 640, the representative method 600 may include, performing a serving cell change from the first serving cell to a second serving cell, wherein the second serving cell may be associated with the indirect path. At block 650, the representative method 600 may include, receiving, from the sidelink relay WTRU, second system information of the second serving cell.

In certain representative embodiments, the representative method 600 may include, releasing a first configuration associated with the multipath connection.

In certain representative embodiments, the first link is a Uu connection.

In certain representative embodiments, receiving the first system information on the first serving cell may comprise monitoring a Uu interface of the first link.

In certain representative embodiments, the second link may be a PC5-RRC connection.

In certain representative embodiments, receiving the second system information on the second serving cell may comprise monitoring a sidelink interface of the second link.

In certain representative embodiments, the message to release the direct path may be an RRC-RELEASE message.

In certain representative embodiments, releasing the configuration associated with the multipath connection may comprise releasing a second configuration associated with one or more direct bearers; and/or changing a primary path of the one or more split bearers from the direct path to the indirect path.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method implemented by a wireless transmit receive unit (WTRU), the method comprising:
receiving, from a network node, configuration information for configuring, by the WTRU, a multipath connection, wherein the multipath connection comprises a direct path via a first link with the network node and an indirect path via a second link, the second link being a sidelink associated with a sidelink relay WTRU;
receiving, from the network node, first system information of a first serving cell, wherein the first serving cell is associated with the direct path;
receiving, from the network node, a radio resource control (RRC) message comprising information indicating to release the direct path and operate using the indirect path;
responsive to the RRC message, releasing the direct path and maintaining operation on the indirect path; and
receiving, from the sidelink relay WTRU, second system information of a second serving cell associated with the indirect path.

2. The method according to claim 1, wherein the first link is a Uu connection.

3. The method according to claim 2, wherein receiving the first system information on the first serving cell comprises monitoring a Uu interface of the first link.

4. The method according to claim 1, wherein the second link is a PC5 radio resource control (RRC) connection.

5. The method according to claim 4, wherein receiving the second system information on the second serving cell comprises monitoring a sidelink interface of the second link.

6. The method according to claim 1, wherein the RCC message to release the direct path is an RRC-RELEASE message.

7. The method according to claim 1, comprising releasing a first configuration associated with the multipath connection.

8. The method according to claim 7, wherein releasing the configuration associated with the multipath connection comprises:
releasing a second configuration associated with one or more direct bearers; and
changing a primary path of the one or more split bearers from the direct path to the indirect path.

9. A wireless transmit/receive unit (WTRU) comprising circuitry, including a transmitter, a receiver, a processor and memory, the WTRU configured to:
receive, from a network node, configuration information for configuring, by the WTRU, a multipath connection, wherein the multipath connection comprises a direct path via a first link with the network node and an indirect path via a second link, the second link being a sidelink associated with a sidelink relay WTRU;
receive, from the network node, first system information of a first serving cell, wherein the first serving cell is a cell associated with the direct path;
receive, from the network node, a radio resource control (RRC) message comprising information indicating to release the direct path and operate using the indirect path an RRC;
responsive to the RRC message, releasing the direct path and maintaining operation on the indirect path; and
receive, from the sidelink relay WTRU, second system information of the a second serving cell associated with the indirect path.

10. The WTRU according to claim 9, wherein the first link is a Uu connection.

11. The WTRU according to claim 10, wherein receiving the first system information on the first serving cell comprises monitoring a Uu interface of the first link.

12. The WTRU according to claim 9, wherein the second link is a PC5 radio resource control (RRC) connection.

13. The WTRU according to claim 12, wherein receiving the second system information on the second serving cell comprises monitoring a sidelink interface of the second link.

14. The WTRU according to claim 9, wherein the RRC message to release the direct path is an RRC-RELEASE message.

15. The WTRU according to claim 9, wherein the WTRU is configured to release a first configuration associated with the multipath connection.

16. The WTRU according to claim 15, wherein the WTRU is configured to:
release a second configuration associated with one or more direct bearers; and
change a primary path of the one or more split bearers from the direct path to the indirect path.

17. The method according to claim 1, wherein the network node is a next generation NodeB (gNB).

18. The network node claim 1, further comprising, after releasing the direct path, operating as a remote WTRU connected to the network via the sidelink relay WTRU.

19. The WTRU according to claim 9, wherein the network node is a next generation NodeB (gNB).

20. The WTRU according to claim 9, wherein the WTRU is further configured to, after releasing the direct path, operate as a remote WTRU connected to the network via the sidelink relay WTRU.
